(19) United States
(12) Patent Application Publication
(10) Pub. No.: US 2025/0136328 A1
(43) Pub. Date: May 1, 2025

(54) Heat-Sealable Two-Piece Seal Comprising A Peelable Lid

(71) Applicant: SELIG FRANCE, Chazay-D'Azergues (FR)

(72) Inventors: Stéphane Triquet, Chazay-D'Azergues (FR); Rémy Bischoff, Chazay-D'Azergues (FR)

(21) Appl. No.: 18/694,290

(22) PCT Filed: Oct. 25, 2022
(86) PCT No.: PCT/FR2022/052019

§ 371 Date: Mar. 21, 2024

(30) Foreign Application Priority Data
Oct. 26, 2021 (FR) FR2111349

(51) Int. Cl. B65D 41/04; B32B 7/12; B32B 15/085; B32B 15/09; B32B 15/12; B32B 15/20; B32B 37/12; B65D 53/04

(52) U.S. Cl. CPC B65D 41/045; B32B 7/12; B32B 15/085; B32B 15/09; B32B 15/12; B32B 15/20; B32B 37/1207; B65D 53/04; B32B 2037/1215; B32B 2305/08; B32B 2307/302; B32B 2307/31; B32B 2307/518; B32B 2307/7376; B65D 2543/00981

(57) ABSTRACT

The invention relates to a heat-sealing two-piece seal for sealing a container having a stopper or a cap-type closure, comprising a support temporarily secured to a lid comprising a sheet of conductive material, characterized in that the sheet of conductive material is provided on its lower face with a reinforcing film having a thickness of less than 6 μm, on the lower face of which a heat-sealing film is applied.

The invention relates to the technical field of means for sealing a containers, particularly ones made of glass, with closure by top or cap, in particular in the field of dry food61 products such as freeze-dried coffees, spreads, etc. without this being limiting. It relates more precisely to a two-part seal comprising a peelable lid.

The sealing of containers with closure by top or cap, prior to their first opening, can be carried out by means of a two-part seal or, in certain cases, a simple lid which can be gluable or sealable, on the mouth.

The invention relates to a two-piece seal only.

A two-part seal consists of a lid placed over the entire periphery of the upper rim of the neck of the container or mouth, thereby isolating the container from the outside, as well as of a generally thicker substrate, inserted, without being otherwise attached, in the bottom of the top. Prior to the first opening of the container, the substrate and the lid can be attached to one another via a temporary adhesive.

The role of the lid is firstly to confer a tamper-proof nature to the container before the first opening. Additionally, it provides the primary seal with respect to the outside. Furthermore, it must develop certain properties of compatibility with the contents that it is supposed to isolate and for example be of food quality whenever the contents are food.

The substrate, for its part, is intended to absorb the tolerances between the bottom of the cap and/or the top and the upper part of the neck of the container, and additionally, to ensure the secondary sealing once the lid has been completely or partially removed. It is therefore capable of ensuring a certain compression with memory effect precisely to allow these tolerances to be absorbed.

In practice, the seal is inserted in the bottom of the cap or of the top. Once the container has been filled, the top or cap equipped with the seal is screwed or snap-fit onto the container. The sealing part of the seal is then in contact with the mouth.

When the container is opened for the first time, the substrate inserted in the bottom of the top detaches from the lid that has remained sealed on the mouth. It is only then that the lid is removed by the consumer; the seal, in the closed position of the container, then only being provided by the substrate part of the seal pressing by compression on the mouth.

The sealing of the lid on the mouth is carried out by bonding or heat-sealing by induction by means of a heat-sealing film or varnish.

The invention is limited to a heat-sealable two-piece seal, which means that the securing of the lid to the mouth is achieved by induction heat-sealing as mentioned above and not by gluing.

Heat-sealing is made possible by the combined action of a conductive material, inserted into the thickness of the seal, which, under the effect of electric induction, heats up, resulting in the softening of the sealing film or varnish on the mouth. The conductive material can be inserted either into the substrate or into the lid. Most often, it is inserted into the thickness of the lid. In practice, it has a thickness of at least 12 micrometers to ensure the conduction of heat.

Documents EP 2 045 194 A1 and WO 2010/115811 describe two-part seals, the lid part of which incorporates an aluminum sheet as conductive material. A first drawback of the prior art lies in the fact that the peeling of the lid cannot be done in one step because the aluminum tears at the time of said peeling.

Indeed, the consumer is used to pulling off the lid either by grasping the edge thereof, or by piercing it substantially at its center. In any case, the peeling of the lid cannot be done in one step.

A second drawback, which is a consequence of the first, resides in the fact that the pulling off of the aluminum generates the presence of metal residues at the surface of the mouth which may fall inside the container and therefore contaminate the contents.

The first problem that the invention proposes to solve is therefore that of developing a lid that can be peeled off without leaving traces of metal on the mouth, ideally a seal peelable all at once.

This problem to be solved is accompanied by an additional constraint which results from the habits of consumers, because as mentioned above, some of them are used to opening the lid by piercing it with their fingers and then gradually pulling off the aluminum strips.

Document U.S. Pat. No. 4,917,949 describes a heat-sealing two-piece seal comprising a substrate and a lid typically made of aluminum. The substrate and the lid are attached together by a temporary adhesive. A 12.7 μm thick layer, made of polyester, is attached to the sheet of aluminum and then a heat-sealable adhesive layer is attached to the polyester layer. The document indicates that the reinforcement layer is used to reinforce the strength of the layer of aluminum, the thickness of the polyester layer associated with the layer of aluminum therefore makes it impossible to pierce the lid with one's finger.

The solution to the stated problem must therefore take into account this reality so as not to disrupt the habits of consumers, especially when it comes to consumer products such as, for example, spreads or freeze-dried coffee.

Therefore, the problem that the invention proposes to solve is that of developing a two-piece seal, the lid of which can be peeled off all at once, without leaving traces of metal on the mouth, while being able to be pierced by the fingers of the consumer at the time of opening.

To this end, a heat-sealable two-piece seal has been developed for sealing a container to be closed by top or cap, comprising a substrate secured, by means of a temporary adhesive, to a lid free of any tabs and comprising a sheet of conductive material.

According to the invention, the sheet of conductive material is provided on its lower face with a reinforcing film having a thickness of less than 6 μm, on the lower face of which a heat-sealing film intended to be in contact with the mouth of said container is applied.

The Applicant had the idea of applying a reinforcing film under the sheet of conductive material, thus making it possible to avoid the deposition of metal residues on the mouth at the time of the peeling, all combined with a specific thickness of said reinforcing film making it possible for the consumer to pierce the lid.

The reinforcing film must be thick enough not to tear at the time of peeling, but sufficiently thin to remain pierceable. In practice, the reinforcing film has a thickness of between 4 and 6 μm, advantageously equal to 4.5 μm.

According to another feature, the reinforcing film is made of a material selected from the group comprising polyester (PET), biaxially oriented polypropylene, biaxially oriented polyamide and biaxially oriented PET.

In a preferred embodiment, the reinforcing film is a PET film and has a thickness of between 4 and 5 μm.

According to an essential feature of the invention, the lid contains a sheet of conductive material. In practice, it is an aluminum sheet.

In order for the two-piece seal of the invention to be heat-sealable, it is necessary for the sheet of conductive material, in this case the sheet of aluminum, to have a sufficient thickness. In practice, the thickness of the sheet is between 20 and 40 microns, advantageously between 10 and 30 microns.

In practice, the reinforcing film, and in general the constituent layers of the substrate and/or of the lid, can be directly associated with one another or by means of a layer of binder. In all cases, the connection is preferably permanent so that the constituent layers of the lid and/or substrate are not separable.

In order to adhere the lid to the mouth of the container, the lower face of the reinforcing film is provided with a heat-sealing film. The heat-sealing film is made of a material of the polyolefin type, selected from the group comprising EVA, polyethylene, polypropylene or PET, of the hot-melt type or else of the terpolymer or ionomer type. Generally, the constituent material of the heat-sealing film is selected based upon the nature of the jar.

The heat-sealing film can be a single-layer film applied to the lower face of the reinforcing film by extrusion. It may also be a bilayer film (an actual heat-sealing lower layer and a binding upper layer) applied to the lower face of the reinforcing film by extrusion.

In practice, the lid has a thickness of between 20 and 200 μm, preferably between 30 and 120 μm.

According to the invention, the lid of the two-piece seal advantageously contains three layers only, respectively from bottom to top, a heat-sealing layer, the reinforcing film, and the sheet of conductive material. In some cases, the upper face of the sheet of conductive material is covered with printing applied by an operation of pre-lacquering and then over-lacquering.

The substrate can be made of any type of compressible material with recovery memory, especially expanded polyethylene or expanded polypropylene, optionally provided on at least one of its two faces with a film of polypropylene or polyethylene in order to grant it a certain rigidity. It can also be made of paper or cardboard.

In practice, the envisaged substrates have a thickness of between 0.5 and 4 mm, advantageously between 0.8 and 2 mm.

Regarding the temporary attachment between the substrate and the lid, this can be obtained by means of a temporary adhesive applied in the form of a film, preferably extruded or co-extruded, each of the two faces of the layer having a different tackiness, the tackier face being applied to the lower surface of the substrate, while the less tacky face is applied to the upper face of the lid. In practice, such a film is polymer-based, generally synthetic, and selected carefully by a person skilled in the art, so as to obtain the sought properties of differential bonding. Such polymers are for example polymers or co-polymers based on acetate, acrylate, polyethylene, etc.

The temporary adhesive may also be provided in the form of a layer of wax.

The lid and the two-part seal of the invention are more particularly suitable for sealing a glass container with closure by top or cap containing dry products, such as spreads or freeze-dried coffee.

The invention and the advantages deriving therefrom will become more apparent from the following example, which constitutes a preferred embodiment.

A seal according to the invention is a heat-sealable two-piece seal. The seal consists of a substrate and a lid without a tab.

The substrate comprises a layer made of expanded polypropylene or polyethylene and has a thickness of between 1.4 and 1.7 mm.

The lid has from its upper face opposite the substrate, towards its lower face opposite the mouth of the jar:
an aluminum sheet having a thickness of 30 μm,
a PET reinforcing film with a thickness of 4.5 μm,
a heat-sealing film of the PE type.

The sheet of aluminum and the PET reinforcing film are made integral by means of a binder layer.

According to the invention, the substrate and the lid are joined by means of an extruded temporary adhesive film of the polyethylene type, both of the faces of the layer having a different tackiness, the tackier face being applied to the lower surface of the substrate, while the less tacky face is applied to the upper face of the lid.

In practice, these seals are positioned as such at the bottom of the cap, the cap then being screwed or clipped onto the neck of the container, whichever the case may be. The seal is heat-sealed by induction.

When the container is opened for the first time, the substrate inserted in the bottom of the top detaches from the lid that has remained sealed on the mouth. It is only then that the lid is removed by the consumer; the seal, in the closed position of the container, then only being provided by the substrate part of the seal pressing by compression on the mouth.

As explained above, the lid can be removed by the consumer either by gripping the periphery of the lid projecting from the mouth or by piercing the lid with their finger, substantially at its center.

Due to the presence of the reinforcing film combined with its thickness, the lid can be removed without leaving any metal traces on the mouth, and potentially in a single step.

The invention and the resulting benefits are clear from the foregoing description. Particularly notable is the possibility of proposing, in a two-piece seal, a seal peelable all at once, leaving no traces of metal traces on the mouth of the container, thus avoiding any risk of contamination of the foodstuffs such as, for example, spreads or freeze-dried coffee that it may contain.

1. A heat-sealing two-piece seal for sealing a container having a stopper or a cap-type closure, the seal comprising:
a substrate made integral, by means of a temporary adhesive, with a cover free of a tab and comprising a sheet of conductive material, wherein the sheet of conductive material is provided on a lower face with a reinforcing film having a thickness of less than 6 μm, on the lower face of which a heat-sealing film is applied, the heat-sealing film configured to contact the mouth of said container.

2. The seal according to claim 1, wherein the reinforcing film has a thickness of between 4 and 6 μm.

3. The seal according to claim 1, wherein the reinforcing film is made of a material selected from the group comprising polyester (PET), biaxially oriented polypropylene, biaxially oriented polyamide and biaxially oriented PET.

4. The seal according to claim 1, wherein the sheet of conductive material is an aluminum sheet.

5. The seal according claim 1, wherein the sheet of conductive material has a thickness of between 20 and 40 μm.

6. The seal according to claim 1, wherein the heat-sealing film comprises polyolefin.

7. The seal according to claim 1, wherein the substrate is made of a compressible material with recovery memory.

8. The seal according to claim 1, wherein the substrate is made of paper.

9. The seal according to claim 1, wherein the seal is configured for use with a glass container containing dry products.

10. The seal according to claim 6, wherein the heat-sealing film comprises at least one of EVA, polyethylene, polypropylene, PET, and hot-melt adhesive.

11. The seal according to claim 7, wherein the compressible material comprises at least one of expanded polyethylene and expanded polypropylene.
